(19) United States
(12) Patent Application Publication
(10) Pub. No.: US 2021/0304627 A1
(43) Pub. Date: Sep. 30, 2021

(54) Recovery and Test Dispatchers for Fleet Management and Flight Planning Systems

(71) Applicant: LOON LLC, Mountain VIew, CA (US)

(72) Inventors: Sameera Sylvia Ponda, Mountain View, CA (US); Salvatore J. Candido, Mountain View, CA (US)

(73) Assignee: LOON LLC, Mountain View, CA (US)

(21) Appl. No.: 16/829,869

(22) Filed: Mar. 25, 2020

(51) Int. Cl. G08G 5/00; B64B 1/40; G05D 1/08; G05D 1/10; G05D 1/00; G08G 5/02

(52) U.S. Cl. CPC G08G 5/0043; B64B 1/40; G05D 1/0808; B64C 39/024; G05D 1/0011; G08G 5/02; G05D 1/104

(57) ABSTRACT

The technology relates to recovery and test dispatchers for fleet management and flight planning systems. A method for dispatching to a decommissioned vehicle zone includes receiving a first input comprising state data of an aerial vehicle and a second input comprising an objective; determining, using the first input, the aerial vehicle meets a set of criteria associated with the objective; selecting a dispatcher configured to dispatch a vehicle to a decommissioned vehicle zone; allocating the aerial vehicle to the dispatcher; and selecting, by the dispatcher, the decommissioned vehicle zone to which the aerial vehicle is to be dispatched, wherein the objective comprises a test objective or recovery objective, and wherein the dispatcher comprises a test dispatcher or recovery dispatcher.

### BACKGROUND OF INVENTION

Fleets of autonomous aerial vehicles are being considered for a variety of purposes, including providing data and network connectivity, data gathering (e.g., image capture, weather and other environmental data, telemetry), surveillance, systems testing, among others. Typically, data and network connectivity have been provided by ground infrastructure that is often expensive and not available to rural, devastated, and offshore areas. Also typically, data gathering and surveillance by aircraft has been conducted with individual aircraft being flown manually, directly piloted onboard or remotely. As these industries look to more efficient means of providing these services with fleets of autonomous vehicles, such as high altitude vehicles, the need for fleet management and flight planning for both homogeneous and heterogeneous fleets of high altitude vehicles has grown.

Conventional flight planning systems are designed typically for aerial vehicles that are manned or perform relatively short flights (i.e., minutes to hours, with a maximum of 24 hour flights). Such conventional flight planning typically is not automated and involves launching and landing aircraft directly to perform one relatively short-term mission or objective at a time, with an expectation that the aircraft will launch and land numerous times, with the capability to land in a short time frame according to a specified trajectory and flight path. Such systems are not capable of dispatching and reallocating high altitude aircraft that are designed to launch infrequently, be deployed to perform longer-term missions (i.e., days, weeks, months or years, rather than hours) and be reallocated to perform multiple objectives without landing and re-launching.

Thus, there is a need for improved dispatchers for fleet management and flight planning.

### BRIEF SUMMARY

The present disclosure provides for techniques relating to recovery and test dispatchers for fleet management and flight planning systems. A method for dispatching to a decommissioned vehicle zone includes receiving a first input comprising state data of an aerial vehicle and a second input comprising an objective; determining, using the first input, the aerial vehicle meets a set of criteria associated with the objective; selecting a dispatcher configured to dispatch a vehicle to a decommissioned vehicle zone; allocating the aerial vehicle to the dispatcher; and selecting, by the dispatcher, the decommissioned vehicle zone to which the aerial vehicle is to be dispatched, wherein the objective comprises a test objective or recovery objective, and wherein the dispatcher comprises a test dispatcher or recovery dispatcher.

In one example, the decommissioned vehicle zone comprises a geographical area for which there are test or recovery objectives to perform. In another example, the decommissioned vehicle zone comprises a test area wherein aerial vehicles can perform test objectives. In another example, the decommissioned vehicle zone comprises a landing area wherein aerial vehicles can land.

In another example, the method also includes simulating, based on a third input comprising a weather forecast for areas around and between a current location of the aerial vehicle and the decommissioned vehicle zone, one or more flights that the aerial vehicle can perform to arrive at the decommissioned vehicle zone; selecting, by the dispatcher, a flight based on a plurality of simulations; and sending, by the dispatcher, a first command to the aerial vehicle, the first command configured to cause the aerial vehicle to navigate to the decommissioned vehicle zone based on the selected flight. In another example, the aerial vehicle is a wind-driven vehicle and the first command comprises an instruction for the aerial vehicle to ascend or descend to an altitude configured to cause the aerial vehicle to be driven by wind in a desired heading.

In still another example, the method also includes determining a distance range from the decommissioned vehicle zone wherein the aerial vehicle should begin a descent to land in the decommissioned vehicle zone, wherein the decommissioned vehicle zone comprises a landing area; and sending a second command to the aerial vehicle when the aerial vehicle is within the distance range. In another example, the aerial vehicle comprises a wind-driven vehicle and the second command comprises a termination command to cause the wind-driven vehicle to begin the descent while continuing to be carried to the landing zone by wind. In another example, the method also includes sending a second command to the aerial vehicle to perform a test objective, wherein the objective comprises the test objective. In another example, the flight is selected based on a shortest distance to the decommissioned vehicle zone. In another example, the flight is selected based on a shortest time of flight to the decommissioned vehicle zone. In another example, the flight is selected based on a time frame when the decommissioned vehicle zone is available for landings. In another example, the state data includes an estimate of remaining lifespan for the aerial vehicle, said remaining lifespan comprising one criterion in the set of criteria for the objective. In another example, the decommissioned vehicle zone overlaps with a service area for which there is a test objective and a service objective. In another example, the objective comprises a test objective associated with gathering environmental data for the service area. In another example, selecting the dispatcher is based on a geographical region associated with the objective.

A distributed computing system for fleet management and flight planning, the system includes one or more computers and one or more storage devices, the one or more storage devices storing instructions that when executed cause the one or more computers to implement; a vehicle allocator configured to receive a first input comprising state data of an aerial vehicle and a second input comprising an objective, determine, using the first input, the aerial vehicle meets a set of criteria associated with the objective, select a dispatcher configured to dispatch a vehicle to a decommissioned vehicle zone, and allocate the aerial vehicle to the dispatcher; and a dispatcher configured to select the decommissioned vehicle zone to which the aerial vehicle is dispatched, the dispatcher comprising a test dispatcher or recovery dispatcher.

In one example, the dispatcher further is configured to select a flight based on a plurality of simulations; and send a first command to the aerial vehicle, the first command configured to cause the aerial vehicle to navigate to the decommissioned vehicle zone based on the selected flight. In another example, the one or more computers reside in a ground station comprising a plurality of server computing devices. In another example, the dispatcher comprises a plurality of dispatchers, each of the plurality of dispatchers being configured to dispatch vehicles to a different geographical region.

### BRIEF DESCRIPTION OF THE DRAWINGS

FIGS. 1A-1B are diagrams of exemplary operational systems in which learned flight policies may be implemented for navigating an aerial vehicle, in accordance with one or more embodiments;

FIG. 2 is a diagram of an exemplary aerial vehicle network, in accordance with one or more embodiments;

FIG. 3A is a simplified block diagram of an exemplary computing system forming part of the systems of FIGS. 1A-2, in accordance with one or more embodiments;

FIG. 3B is a simplified block diagram of an exemplary distributed computing system, in accordance with one or more embodiments;

FIG. 4 is a simplified block diagram of an exemplary dispatch system implemented by a plurality of server computing devices, in accordance with one or more embodiments;

FIG. 5 is a simplified block diagram of an exemplary fleet management and flight planning system implementing dispatchers, in accordance with one or more embodiments;

FIG. 6 is a simplified block diagram of exemplary dispatchers dispatching vehicles, in accordance with one or more embodiments;

FIG. 7 is another simplified block diagram of exemplary dispatchers dispatching vehicles, in accordance with one or more embodiments;

FIGS. 8A-B are flow diagrams illustrating methods for allocating an aerial vehicle to a test or recovery dispatcher to fulfill an objective, in accordance with one or more embodiments; and

FIG. 9 is a flow diagram illustrating a method for selecting a decommissioned vehicle zone, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for dispatching fleets of aircraft by a fleet management and flight planning system. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driven vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to a set of test and recovery dispatcher modules in a dispatch system for fleet management and flight planning, the test and recovery dispatcher modules configured to handle test and recovery operations (i.e., testing and/or landing (e.g., for maintenance, inspection, termination, rest or offline period), periodically or ad hoc) for a fleet of aerial vehicles (e.g., wind-driven or other high altitude vehicles). These dispatchers are responsible for operating flights in zones designated for decommissioned vehicle flights (i.e., flights by vehicles that do not meet criteria for fulfilling service objectives), such as test flights (i.e., fulfilling test objectives) and landing (i.e., termination of flight). Once a vehicle is ready to be decommissioned or is otherwise no longer available or capable for use in service, it gets allocated to a test or recovery dispatcher by a dispatcher allocator or vehicle allocator.

Test zones may be areas where aerial vehicles may be tested and flown until designated for landing. In some examples, test zones may be located over the ocean, isolated rural regions of land, or other areas with little to no human population. In other examples, a test zone may be an area that geographically overlaps with a service zone, and for which real-time environmental data (e.g., ambient pressures and temperatures, wind speeds at different altitudes, other characteristics of the ambient air, images of the Earth or cloud cover or other aspects of the area) is desired. A vehicle may be allocated for test zone activities, such as fulfilling test objectives, based on various factors, such as age or lifetime estimation (e.g., there may be a lifetime threshold for service vehicles that is different from another lifetime threshold for test vehicles, and yet another lifetime threshold for termination), new vehicle or component design (e.g., new film or envelope type for a balloon, new hardware, new navigation software, new flight policies), versioning (e.g., old software or hardware taken out of service or no longer compatible with related systems), gas levels, or non-fatal system errors, faults or failures. Test dispatcher can automatically assign vehicles to a test zone (i.e., select a test zone for a vehicle assigned to test dispatcher), drive a vehicle to a test zone, redirect a vehicle back into a test zone or to another test zone (e.g., when the vehicle unexpectedly drifts out of the test zone in the performance of a test flight), among other tasks.

Recovery or landing zones are places where there is authorization to land vehicles. Flight systems or engineering teams may manage relationships with air traffic control to determine times and locations for landing and recovery. Recovery dispatcher may (1) choose a landing zone based on, e.g., landing objectives, travel time to a landing zone (e.g., minimizing, maximizing, ensuring travel time is within or less than a remaining lifetime estimation), landing zone availability, other scheduled landings, and other factors, (2) schedule the landing flight, and (3) drive a vehicle to a target landing area or location (e.g., by sending requests to a planner or other navigation software to determine an appropriate or optimized trajectory or set of actions). For example, recovery dispatcher can select a closest available landing area and schedule a descent to meet recovery requirements (e.g., landing prior to an expected vehicle lifetime end date, within a time frame on a designated date, within a time frame on any day of a designated week, at a designated date and time) by doing one or more of the following: (a) calculating a distance to each of a set of available landing areas within a given region, and selecting a landing area based on predetermined criteria (e.g., shortest distance from vehicle, shortest time to arrive, most likely to arrive within a desired time window, each of which may be modeled or simulated); (b) schedule and plan a trajectory to a landing area; (c) run simulations to determine a protocol to land a balloon at a specific target location (e.g., predict specific time/place to cut down); (d) assign a vehicle to a type of planner to drive the vehicle to a selected target zone or specific target location; (e) schedule arrival in a zone or location during hours of operation or target time windows, either on a specific date or on a group of days (e.g., Monday through Friday) during which the landing zone or location is available; (f) schedule and plan arrivals of multiple vehicles to ensure each vehicle landing is separated by a sufficient amount of time or distance (e.g., provide a sufficient time window for each landing such that there is both a buffer for each vehicle to land early or late and for each vehicle to be cleared before another vehicle lands; provide sufficient distance between expected landings such that even if more than one vehicle lands at or around the same time, they do not make contact with each other in the descent or upon landing), among other multi-vehicle landing concerns.

Vehicles may be allocated to a recovery or test dispatcher by a vehicle allocator according to factors (i.e., criteria) such as need (i.e., bandwidth demand), priority (e.g., high priority test objectives, low priority vehicle types), vehicle age, vehicle class, component wear and usage rates (e.g., age or usage of an altitude control system or other component). The region may require certain communications capabilities (e.g., a region may employ a certain type of infrastructure that can only communicate using certain protocols, standards, or within limited wavelength spectrums). For a lighter-than-air vehicle (e.g., aerial vehicles 102a-b), a certain class of balloon may be allocated automatically to a test zone, for instance, vehicles with brand new balloon envelopes or other components that require testing prior to service deployment. Also for lighter-than-air vehicles, allocation to a type of dispatcher may depend in part on a gas level threshold, of which there may be several. For example, a conservative gas level threshold may be designated for full or optimal range of steering capabilities, below which a vehicle may be deemed not reliable enough for commercial service, but still able to continue flights for test objectives. Another gas level threshold may be designated, below which a vehicle may have a smaller steering range and should be restricted to performing tests near landing zones where they may be terminated more quickly. Yet another gas level threshold may be designated below which a vehicle should be terminated. In some examples, the gas level thresholds may be combined with ballast availability to determine an appropriate type of dispatcher to which a vehicle may be allocated. In other examples, vehicles may be allocated to a recovery dispatcher to test non-hardware systems (e.g., new steering algorithms, new LTE network optimizations).

In various types of vehicles, allocation to a type of dispatcher may be based on a lifetime estimation determined by an estimator, which may determine remaining lifetime based on a gas threshold (e.g., one or more of the gas thresholds described above), remaining ballast, probability of hardware failure, environmental conditions (e.g., forecasted for expected flight path) and other factors). For example, lifetime estimation may calculate a probability of failure (e.g., 1-P(any component failing)) of a vehicle or vehicle component given certain ambient temperature and infrared radiation conditions. In still other examples, vehicles may be allocated for a test dispatcher due to failure of a service component (e.g., LTE unit, parabolic reflectors, primary battery or power source designated for communications units, among others) on the vehicle, while the vehicle's remaining flight and sensor components remain operational (e.g., balloon in tact, ACS functional, backup battery power sufficient, among others). In yet other examples, a vehicle may be allocated to a test dispatcher if its probability of failure of a component goes above a certain threshold, whether or not the component remains functioning. This may be based on historical or test data (e.g., lab testing and reliability data, previous flight tests, established safety limits). In some limited circumstances, a vehicle with a near-critical failure may be determined to have an ability to navigate to and remain in a test zone (e.g., a battery or ballonet or other component is damaged, but at least a minimal flight capability remains) may be allocated to a test dispatcher to gather data on its failures (i.e., an objective) before being allocated to a recovery dispatcher for landing.

In some examples, a vehicle may be taken out of service, or otherwise allocated to a test or recovery dispatcher, based simply on operation outside of known data bounds. For example, an overall age of a platform can be cause to stop flying it over people simply because of a lack of historical data of vehicles of that age being safe, even if other indications show it is safe (e.g., a maximum lifetime estimate may be set for a type, class, or group of vehicles simply due to such lack of data).

In some examples, a vehicle may be conditionally allocated to a dispatcher, based on gas and ballast levels, lifetime estimation, and other factors. For example, given certain gas and ballast levels for a wind-driven vehicle, its lifetime estimation may be very different if it is allocated to a more temperate (e.g., warmer) climate than if allocated to a harsher (e.g., colder) climate. Lifetime estimation for a vehicle also may vary based on vehicle type (e.g., wind-driven, propulsion-capable, fixed-wing). Thus, a vehicle allocator may conditionally allocate a vehicle to a dispatcher configured to dispatch vehicles to a region that is partially or mostly comprised of warmer or more temperate climate areas on the condition that the vehicle remain in these more temperate climates. In other examples, a more robust vehicle (e.g., longer lifetime estimation, healthier or newer onboard batteries or power management systems, otherwise structurally designed to withstand harsher climates) may be allocated to a dispatcher configured to dispatch vehicles to a region comprised partially or mostly of harsher climates to remain with that dispatcher until the vehicle no longer meets the criteria, as described herein. However, the more robust vehicle also may be conditionally allocated to such a dispatcher on the condition that the more robust vehicle be dispatched to the harsher climate for no more than a certain amount of time, or be periodically cycled out of the harsher climate, or on other conditions.

In some examples, a vehicle allocator may use inputs, such as objectives, fleet vehicle availability, fleet vehicle state and characteristics (e.g., current location, steering ability, communications unit types, aircraft type, hardware and software versions, and more), and assign or allocate each vehicle to a dispatcher in accordance with objectives matched to the dispatcher. In other examples, dispatchers may bid on vehicles based on the objectives for their region or purpose. Once a vehicle is allocated to a recovery dispatcher, the vehicle may be in the recovery dispatcher's domain until it no longer meets the criteria for the recovery dispatcher (i.e., the dispatcher's objectives) and is reallocated.

A real-time assurance layer system may govern overriding intents such as avoiding dangerous weather, zero pressure, and no-fly zones. These intents will override any instructions provided by a recovery dispatcher, under predetermined circumstances, and while the overriding intent is applicable, an appropriate controller (e.g., configured to avoid dangerous weather, avoid zero pressure conditions, or navigate around no-fly zones) designed to control a vehicle according to a particular overriding intent shall be given control of the vehicle until that overriding intent is satisfied or disappears (i.e., overriding intent condition is cleared or no longer relevant).

The vehicle allocator and recovery dispatcher may receive input relating to a lifetime estimate for each vehicle, which may be determined by a lifetime estimation stack. The lifetime estimation stack may comprise a set of estimates that inform a calculation of a vehicle's future viability, and often including a margin of error. For a wind-driven vehicle, the set of estimates may include an estimate of remaining lift gas and ballast, an estimate of amount of days of reliable operation for the ACS (e.g., based on an amount of usage of a compressor thus far, monitoring signals such as vibration from the system, an extrapolation of continued usage, for example, until a reliability threshold is met or exceeded, beyond which the wind-driven vehicle may be allocated for recovery, among other factors). For any type of vehicle, there may be other system safety limits that may impose a maximum lifetime for a given vehicle or vehicle type (e.g., a maximum lifetime for a high altitude vehicle may be anywhere from 100 to 200 days or more). In some examples, a maximum lifetime may be based on limitations derived from flight critical components (e.g., the flight critical component that is most constraining at the time of estimation providing an outside or maximum lifetime estimate, a probabilistic computation of risk combining individual failure probabilities of some or all components), systems simulations, other test or simulation data, rules or regulations. The lifetime estimation stack may be configured to estimate these and other factors related to a vehicle's remaining lifetime periodically or continuously (i.e., re-calculating or re-calibrating after each estimate is complete), and providing signals to the vehicle allocator and/or the recovery dispatcher to indicate when a vehicle needs to be decommissioned.

In some examples, a health monitoring system may be employed to provide data to the lifetime estimation stack. The health monitoring system may obtain sensor and other state data (e.g., pressure in a balloon, atmospheric pressure, GPS location, altitude, temperature of various elements, amount of gas in a balloon, amount of air in a balloon, amount of ballast on a balloon, gas leak rate, and more) from each vehicle in the fleet in order to monitor the health of each vehicle's subsystems. In some examples, the lifetime estimation stack may use the information from the health monitoring system to estimate the remaining life of a vehicle (e.g., using a probabilistic estimation model (such as an Extended Kalman Filter) or heuristic model that accounts for relevant weighted factors or a machine learning model trained on health monitoring inputs). Either with the health input, or separate therefrom, the lifetime estimation stack also may receive and consider information (i.e., inputs) related to battery information, power consumption information, UV filters, ACS life (i.e., usage rate), and other factors that may contribute to the reduction in an aerial vehicle's remaining lifetime. In other examples, the lifetime estimation stack may determine a remaining lifetime based on a beginning gas level and actual and/or extrapolated gas leak rates. In still other examples, the lifetime estimation stack may generate a histogram of remaining lifetime by running a plurality of Monte Carlo simulations using inputs such as starting gas level, gas leak rate, location(s) of the vehicle, temperature of the Earth at said location(s), weight of vehicle, ballast management, and other inputs.

In some examples, there may be a second layer of control configured to detect sporadic (i.e., unforecasted) failures in a vehicle. This second layer may signal a recovery dispatcher of unforeseen issues that would require navigating a vehicle to a recovery zone within a shortened time frame (e.g., shortened from a previous lifetime estimate). In other examples, there may be a third layer of control configured to provide manual access to indicate the need to manually steer a vehicle to a landing zone. For example, a tool or user interface may be provided to an operations team (e.g., flight engineers) to provide manual override capabilities (e.g., through tagging, entered commands, other selective manual changes).

### Example Systems

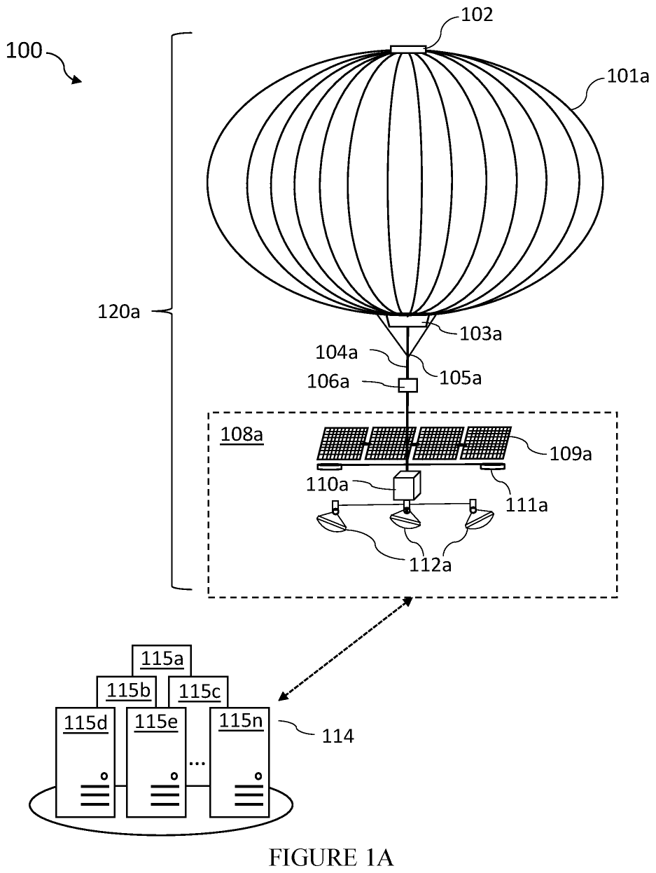

FIGS. 1A-1B are diagrams of exemplary operational systems in which flight policies may be implemented for navigating an aerial vehicle, in accordance with one or more embodiments. In FIG. 1A, there is shown a diagram of system 100 for navigation of aerial vehicle 120a. In some examples, aerial vehicle 120a may be a passive vehicle, such as a balloon or satellite, wherein most of its directional movement is a result of environmental forces, such as wind and gravity. In other examples, aerial vehicles 120a may be actively propelled. In an embodiment, system 100 may include aerial vehicle 120a and ground station 114. In this embodiment, aerial vehicle 120a may include balloon 101a, plate 102, altitude control system (ACS) 103a, connection 104a, joint 105a, actuation module 106a, and payload 108a. In some examples, plate 102 may provide structural and electrical connections and infrastructure. Plate 102 may be positioned at the apex of balloon 101a and may serve to couple together various parts of balloon 101a. In other examples, plate 102 also may include a flight termination unit, such as one or more blades and an actuator to selectively cut a portion and/or a layer of balloon 101a. ACS 103a may include structural and electrical connections and infrastructure, including components (e.g., fans, valves, actuators, etc.) used to, for example, add and remove air from balloon 101a (i.e., in some examples, balloon 101a may include an interior ballonet within its outer, more rigid shell that is inflated and deflated), causing balloon 101a to ascend or descend, for example, to catch stratospheric winds to move in a desired direction. Balloon 101a may comprise a balloon envelope comprised of lightweight and/or flexible latex or rubber materials (e.g., polyethylene, polyethylene terephthalate, chloroprene), tendons (e.g., attached at one end to plate 102 and at another end to ACS 103a) to provide strength to the balloon structure, a ballonet, along with other structural components.

Connection 104a may structurally, electrically, and communicatively, connect balloon 101a and/or ACS 103a to various components comprising payload 108a. In some examples, connection 104a may provide two-way communication and electrical connections, and even two-way power connections. Connection 104a may include a joint 105a, configured to allow the portion above joint 105a to pivot about one or more axes (e.g., allowing either balloon 101a or payload 108a to tilt and turn). Actuation module 106a may provide a means to actively turn payload 108a for various purposes, such as improved aerodynamics, facing or tilting solar panel(s) 109a advantageously, directing payload 108a and propulsion units (e.g., propellers 107 in FIG. 1B) for propelled flight, or directing components of payload 108a advantageously.

Payload 108a may include solar panel(s) 109a, avionics chassis 110a, broadband communications unit(s) 111a, and terminal(s) 112a. Solar panel(s) 109a may be configured to capture solar energy to be provided to a battery or other energy storage unit, for example, housed within avionics chassis 110a. Avionics chassis 110a also may house a flight computer (e.g., computing device 301, as described herein), a transponder, along with other control and communications infrastructure (e.g., a controller comprising another computing device and/or logic circuit configured to control aerial vehicle 120a). Communications unit(s) 111a may include hardware to provide wireless network access (e.g., LTE, fixed wireless broadband via 5G, Internet of Things (IoT) network, free space optical network or other broadband networks). Terminal(s) 112a may comprise one or more parabolic reflectors (e.g., dishes) coupled to an antenna and a gimbal or pivot mechanism (e.g., including an actuator comprising a motor). Terminal(s) 112(a) may be configured to receive or transmit radio waves to beam data long distances (e.g., using the millimeter wave spectrum or higher frequency radio signals). In some examples, terminal(s) 112a may have very high bandwidth capabilities. Terminal(s) 112a also may be configured to have a large range of pivot motion for precise pointing performance. Terminal(s) 112a also may be made of lightweight materials.

In other examples, payload 108a may include fewer or more components, including propellers 107 as shown in FIG. 1B, which may be configured to propel aerial vehicles 120a-b in a given direction. In still other examples, payload 108a may include still other components well known in the art to be beneficial to flight capabilities of an aerial vehicle. For example, payload 108a also may include energy capturing units apart from solar panel(s) 109a (e.g., rotors or other blades (not shown) configured to be spun by wind to generate energy). In another example, payload 108a may further include or be coupled to an imaging device, such as a downward-facing camera and/or a star tracker. In yet another example, payload 108a also may include various sensors (not shown), for example, housed within avionics chassis 110a or otherwise coupled to connection 104a or balloon 101a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

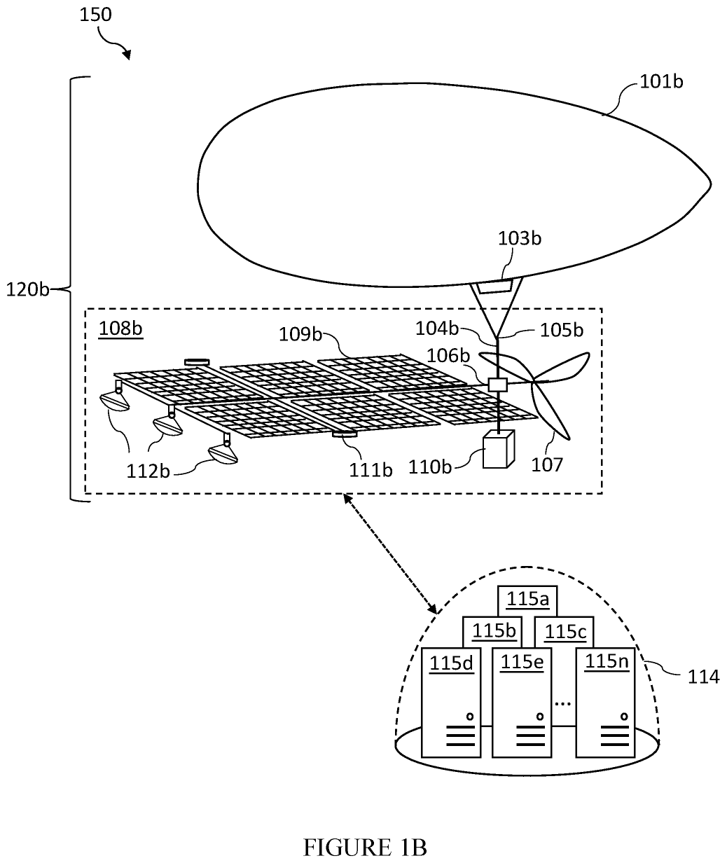

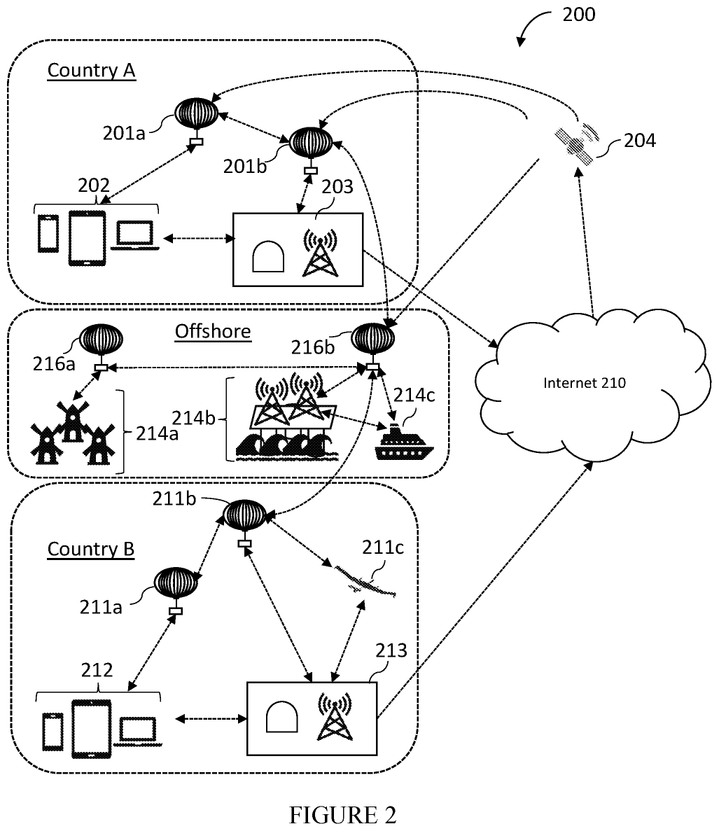

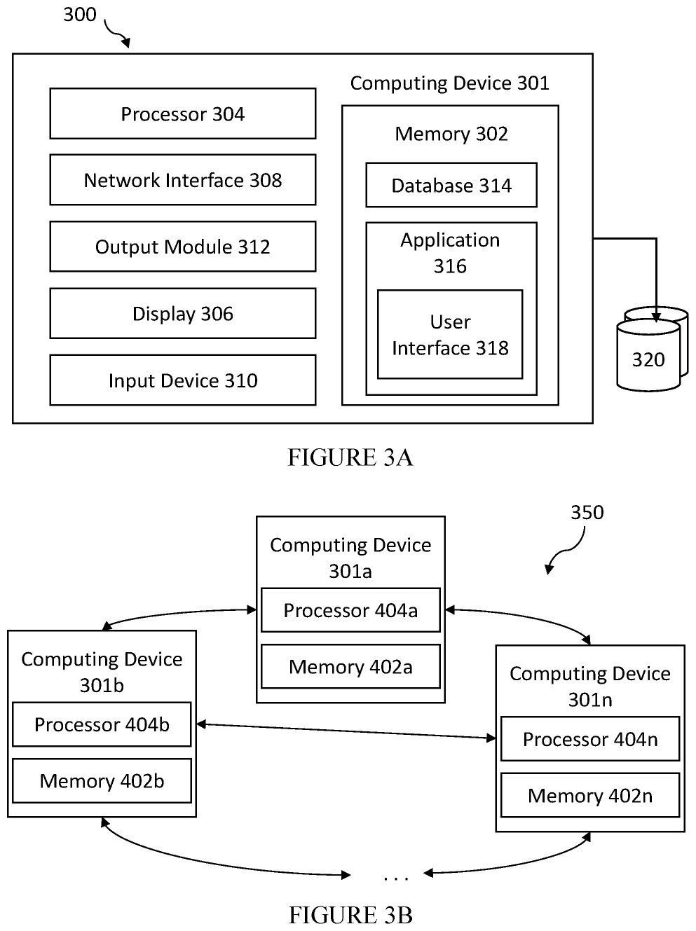

Ground station 114 may include one or more server computing devices 115a-n, which in turn may comprise one or more computing devices (e.g., computing device 301 in FIG. 3). In some examples, ground station 114 also may include one or more storage systems, either housed within server computing devices 115a-n, or separately (see, e.g., computing device 301 and repositories 320). Ground station 114 may be a datacenter servicing various nodes of one or more networks (e.g., aerial vehicle network 200 in FIG. 2).

FIG. 1B shows a diagram of system 150 for navigation of aerial vehicle 120b. All like-numbered elements in FIG. 1B are the same or similar to their corresponding elements in FIG. 1A, as described above (e.g., balloon 101a and balloon 101b may serve the same function, and may operate the same as, or similar to, each other). In this embodiment, aerial vehicle 120b further includes, as part of payload 108b, propellers 107, which may be configured to actively propel aerial vehicle 120b in a desired direction, either with or against a wind force to speed up, slow down, or re-direct, aerial vehicle 120b. In this embodiment, balloon 101b also may be shaped differently from balloon 101a, to provide different aerodynamic properties.

As shown in FIGS. 1A-1B, aerial vehicles 120a-b may be largely wind-influenced aerial vehicle, for example, balloons carrying a payload (with or without propulsion capabilities) as shown, or fixed wing high altitude drones (e.g., aerial vehicle 211c in FIG. 2) with gliding and/or full propulsion capabilities. However, those skilled in the art will recognize that the systems and methods disclosed herein may similarly apply and be usable by various other types of aerial vehicles.

FIG. 2 is a diagram of an exemplary aerial vehicle network, in accordance with one or more embodiments. Aerial vehicle network 200 may include aerial vehicles 201a-b, user devices 202, and ground infrastructure 203, in Country A. Aerial vehicle network 200 also may include aerial vehicles 211a-c, user devices 212, and ground infrastructure 213 in Country B. Aerial vehicle network 200 also may include offshore facilities 214a-c and aerial vehicles 216a-b servicing at least said offshore facilities 214a-c. Aerial network 200 may further include satellite 204 and Internet 210. Aerial vehicles 201a-b, 211a-c, and 216a-b may comprise balloon, other floating (i.e., lighter than air), propelled or partially propelled (i.e., propelled for a limited amount of time or under certain circumstances, and not propelled at other times or under other circumstances), fixed-wing, or other types of high altitude aerial vehicles, as described herein. For example, aerial vehicles 201a-b, 211a-c, and 216a-b may be the same or similar to aerial vehicles 120a-b described above. User devices 202 and 212 may include a cellular phone, tablet computer, smart phone, desktop computer, laptop computer, and/or any other computing device known to those skilled in the art. Ground infrastructure 203 and 213 may include always-on or fixed location computing device (i.e., capable of receiving fixed broadband transmissions), ground terminal (e.g., ground station 114), tower (e.g., a cellular tower), and/or any other fixed or portable ground infrastructure for receiving and transmitting various modes of connectivity described herein known to those skilled in the art. User devices 202 and 212, ground infrastructure 203 and 213, and offshore facilities 214a-c, may be capable of receiving and transmitting signals to and from aerial vehicles 201a-b, 211a-c, and 216a-b, and in some cases, to and from each other. Offshore facilities 214a-c may include industrial facilities (e.g., wind farms, oil rigs and wells), commercial transport (e.g., container ships, other cargo ships, tankers, other merchant ships, ferries, cruise ships, other passenger ships), and other offshore applications.

Aerial vehicle network 200 may support ground-to-vehicle communication and connectivity, as shown between ground infrastructure 203 and aerial vehicle 201b, as well as aerial vehicles 211b-c and ground infrastructure 213. In these examples, aerial vehicles 201b and 211b-c each may exchange data with either or both a ground station (e.g., ground station 114), a tower, or other ground structures configured to connect with a grid, Internet, broadband, and the like. Aerial vehicle network 200 also may support vehicle-to-vehicle (e.g., between aerial vehicles 201a and 201b, between aerial vehicles 211a-c, between aerial vehicles 216a-b, between aerial vehicles 201b and 216b, between aerial vehicles 211b and 216b), satellite-to-vehicle (e.g., between satellite 204 and aerial vehicles 201a-b, between satellite 204 and aerial vehicle 216b), vehicle-to-user device (e.g., between aerial vehicle 201a and user devices 202, between aerial vehicle 211a and user devices 212), and vehicle-to-offshore facility (e.g., between one or both of aerial vehicles 216a-b and one or more of offshore facilities 214a-c) communication and connectivity. In some examples, ground stations within ground infrastructures 203 and 213 may provide core network functions, such as connecting to the Internet and core cellular data network (e.g., connecting to LTE EPC or other communications platforms, and a software defined network system) and performing mission control functions. In some examples, the ground-to-vehicle, vehicle-to-vehicle, and satellite-to-vehicle communication and connectivity enables distribution of connectivity with minimal ground infrastructure. For example, aerial vehicles 201a-b, 211a-c, and 216a-b may serve as base stations (e.g., LTE eNodeB base stations), capable of both connecting to the core network (e.g., Internet and core cellular data network), as well as delivering connectivity to each other, to user devices 202 and 212, and to offshore facilities 214a-c. As such, aerial vehicles 201a-b and 211a-c represent a distribution layer of aerial vehicle network 200. User devices 202 and 212 each may access cellular data and Internet connections directly from aerial vehicles 201a-b and 211a-c.

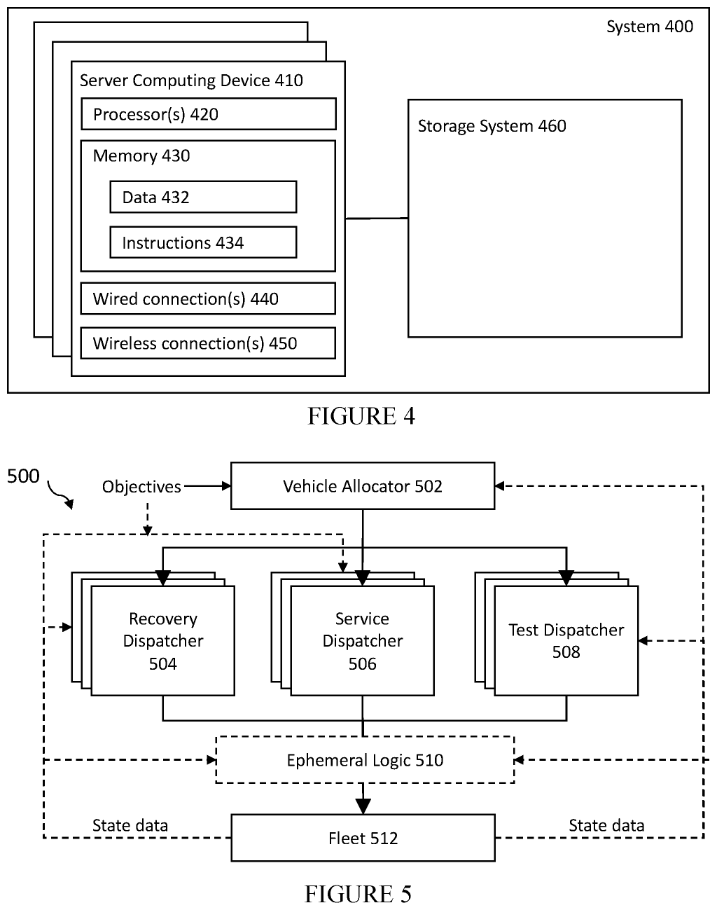

FIG. 3A is a simplified block diagram of an exemplary computing system forming part of the systems of FIGS. 1A-2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301 (not shown). In some examples, storage system 320 may store state data, commands, flight policies, and other various types of information as described herein. This information may be retrieved or otherwise accessed by one or more computing devices, such as computing device 301 or server computing devices 410 in FIG. 4, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 400 in FIG. 3B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks (e.g., encoding flight policies, as described herein) and data regarding wind patterns, weather forecasts, past and present locations of aerial vehicles (e.g., aerial vehicles 120a-b, 201a-b, 211a-c), sensor data, map information, air traffic information, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In some examples computing device 301 may be located remote from an aerial vehicle (e.g., aerial vehicles 120a-b, 201a-b, 211a-c) and may communicate with and/or control the operations of an aerial vehicle, or its control infrastructure as may be housed in avionics chassis 110a-b, via a network. In one embodiment, computing device 301 is a data center or other control facility (e.g., configured to run a distributed computing system as described herein), and may communicate with a controller and/or flight computer housed in avionics chassis 110a-b via a network. As described herein, system 300, and particularly computing device 301, may be used for planning a flight path or course for an aerial vehicle based on wind and weather forecasts to move said aerial vehicle along a desired heading or within a desired radius of a target location. Various configurations of system 300 are envisioned, and various steps and/or functions of the processes described below may be shared among the various devices of system 300, or may be assigned to specific devices.

FIG. 3B is a simplified block diagram of an exemplary distributed computing system, in accordance with one or more embodiments. System 350 may comprise two or more computing devices 301a-n. In some examples, each of 301a-n may comprise one or more of processors 404a-n, respectively, and one or more of memory 402a-n, respectively. Processors 404a-n may function similarly to processor 304 in FIG. 3, as described above. Memory 402a-n may function similarly to memory 302 in FIG. 3, as described above.

FIG. 4 is an example of a dispatch system 400 which may be, for instance, incorporated into ground stations or other infrastructure (e.g., as shown in FIGS. 1A-1B and 2), and which may be implemented in a distributed computing system (e.g., as shown in FIG. 3B). The dispatch system 400 may include one or more server computing devices 410 and a storage system 460. A ground station may comprise a data center including storage system 460 as well as the server computing devices 410. In this regard, server computing devices 410 may function as a load balanced server farm in order to exchange information with different nodes of various networks for the purpose of receiving, processing and transmitting the data to and from other computing devices. As such, each of the one or more server computing devices 410 may include one or more processors 420, memory 430 and other components typically present in general purpose computing devices.

The memory 430 stores information accessible by the one or more processors 420, including instructions 434 and data 432 that may be executed or otherwise used by the processor 420. The memory 430 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 434 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 432 may be retrieved, stored or modified by processor 420 in accordance with the instructions 434. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any given point in time as well as information about the location of network targets.

The one or more processor 420 may be any conventional processors, such as commercially available CPUs or GPUs. Alternatively, the one or more processors may be a dedicated device such as an ASIC or other hardware-based processor. Although FIG. 4 functionally illustrates the processor, memory, and other elements of the server computing devices 410 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of server computing devices 410. Accordingly, references to a processor or computing device will be understood to include references to a collection of processors or computing devices or memories that may or may not operate in parallel.

The server computing devices 410 may also include one or more wired connections 440 and wireless connections 450 to facilitate communication with other devices, such as the storage system 460, one or more information services, and other devices of the system 100.

As with memory 430, storage system 460 can be of any type of computer storage capable of storing information accessible by the server computing devices 410, such as a hard-drive, memory card, ROM, RAM, DVD, CD-ROM, write-capable, and read-only memories. In addition, storage system 460 may include a distributed storage system where data is stored on a plurality of different storage devices which may be physically located at the same or different geographic locations. Storage system 460 may be connected to the server computing devices 410 directly (i.e. as part of server computing devices 410 and/or via wired connections 440) and/or via a network (i.e. via wired connections 440 and/or wireless connections 450). This network may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Storage system 460 and/or memory 430 may store various types of information as described in more detail below. This information may be retrieved or otherwise accessed by one or more server computing devices, such as the server computing devices 410, in order to perform some or all of the features described herein. For instance, the storage system 460 and/or memory 430 may store state information for each aerial vehicle of the fleet. This state information may include various information such as last received or current location, heading, speed, gas level, air level, other sensor data, how long the aerial vehicle has been in flight, a current mission or operational goal (i.e., objective) for the aerial vehicle, a current intent (overriding or otherwise, as described herein) for the aerial vehicle, battery information (charge, capacity, discharge rate, etc.), end of life date and/or current remaining lifetime as discussed herein, etc. The state information may also include information such as simulation of flights (e.g., comprising a series of trajectories, headings, altitudes, or the like), automated analysis of remaining lifetime, alarms that may be alerting various conditions that may be met on the system, and various other data streams produced to allow high level decision making for a fleet of aerial vehicles. In some examples, state messages and any other data may be stored in a buffer of the storage system 460 and/or memory 430, from which one or more components of the fleet management and flight planning system (e.g., a vehicle allocator, a dispatcher, or the like) may obtain state data.

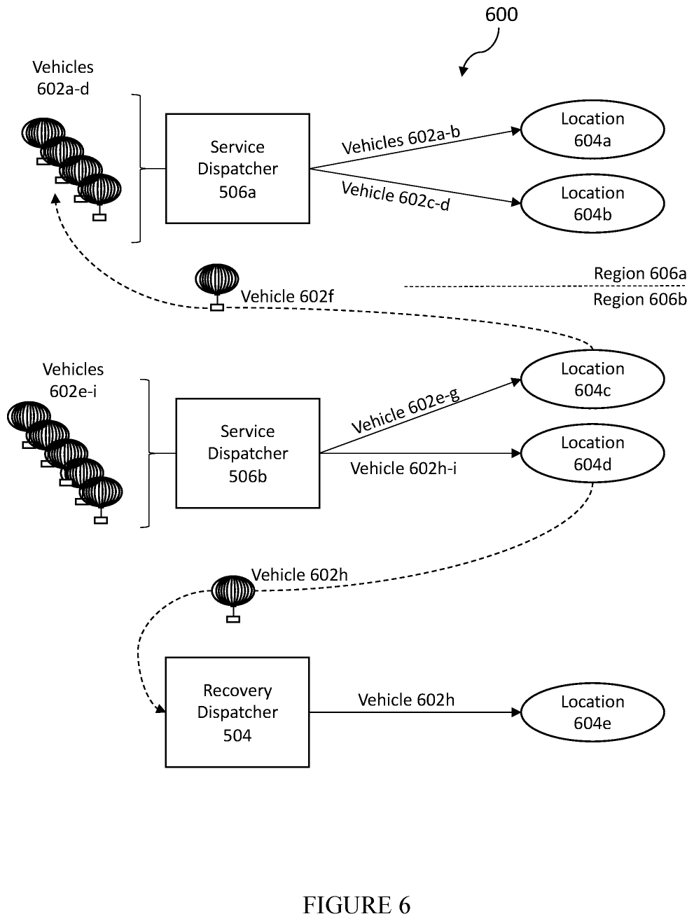

The storage system 460 and/or memory 430 may also store various software modules of the dispatch system 400. For example, the dispatch system 400 may include various software modules including one or more allocator software modules (e.g., vehicle allocator 502 in FIG. 5), a set of rules for the allocator software module, real-time assurance layer (e.g. ephemeral logic 510), as well as a plurality of dispatcher software modules (e.g., recovery dispatcher 504, service dispatcher 506, test dispatcher 508, in FIGS. 5-7, or other dispatchers). The allocator software modules may allocate each of the aerial vehicles to one of a plurality of dispatcher software modules as discussed herein.

The storage system 460 and/or memory 430 may also store current goals or objectives for the systems described herein. This may include, for instance, the number of aerial vehicles needed for a particular service, operational, testing or termination goal and/or location. These goals may be defined at least in part at the allocator software modules and/or the dispatcher software modules. For instance, changing the set of rules of the allocator software module may change how aerial vehicles are allocated. Similarly, by changing the set of rules of the dispatcher software modules, this may change the goals and intents determined by the dispatcher software module.

Storage system 460 and/or memory 430 may also store controllers, commands, navigation maps which can be used to generate flight plans, and some or all of a fleet management and flight planning system implementing dispatchers, as discussed further below. Each navigation map may be a map of wind and/or other weather data, which may be used to navigate an aerial vehicle to a particular location.

FIG. 5 is a simplified block diagram of an exemplary fleet management and flight planning system implementing dispatchers, in accordance with one or more embodiments. System 500 may include vehicle allocator 502, one or more recovery dispatcher(s) 504, one or more service dispatcher(s) 506, one or more test dispatcher(s) 508, and ephemeral logic 510. In some examples, system 500 may include one or more other dispatcher types directed to dispatching vehicles for different purposes (e.g., Earth image capture, environmental data gathering, surveillance, or other purpose). As shown, vehicle allocator 502, recovery dispatcher 504, service dispatcher 506, test dispatcher 508, and ephemeral logic 510 (if included in the system), may receive state data from fleet 512 (i.e., state data for each vehicle in fleet 512) as well as various objectives to be fulfilled by fleet 512. In some examples, ephemeral logic 510 may comprise its own vehicle allocator and set of dispatchers, for example, in parallel to vehicle allocator 502 and dispatchers 504-508, whereby an override by ephemeral logic 510 is unknown to vehicle allocator 502 (e.g., vehicle allocator 502 is unaware it is being overridden).

Such state data may originate as telemetry from aerial vehicles in fleet 512, and be augmented by various systems (e.g., flight telemetry joiners, flight data aggregators, estimators, simulators, etc.), prior to being shared with vehicle allocator 502 or dispatchers 504-508. Such state data may provide one or any combination of: current location information (e.g., latitude, longitude, altitude), current heading (e.g., trajectory, direction or range of directions traveled or expected to be traveled), battery information (e.g., charge, capacity, discharge rate, etc.), other current flight information (e.g., launch time, flight name, operational notes), vehicle age, lifetime estimation, system faults or failures, modes, software version, operational hardware capabilities, communications hardware capabilities, other vehicle configuration information (e.g., number of solar panels, serial number of support structures, etc.), and more. State data also may include meteorological data for storms or weather conditions, population density on the Earth and over which the aerial vehicles may fly, aircraft density in the air among which the aerial vehicles may fly, and other environmental data relevant to the operation of fleet 512. The state messages may be transmitted by aerial vehicles in fleet 512 to vehicle allocator 502, any dispatcher, or ephemeral logic 510 periodically, continuously, on an ad hoc basis, or another schedule. State data may also or alternatively include the output of estimators and simulators that may provide stateful derived computations from telemetry, (e.g., an estimate of remaining lift gas, projections of the aerial vehicle's trajectory and flight path).

Example objectives may include, without limitation, service objectives, such as arriving at a target service region on a given date or time window; providing connectivity services (e.g., non-terrestrial communications network services, such as LTE, internet of things, or fixed broadband service) to the target service region for a minimum, maximum, or predetermined time period (e.g., number of days, weeks, hours, daily time range indicated by start and stop times or number of hours each day, weekly time range indicated by start and stop days and times or number of days each week, and the like); otherwise maximizing or optimizing an amount of time an aerial vehicle provides connectivity services to a target service region; providing relay services to other vehicles in a mesh network (i.e., serve as a backbone to connect other vehicles to the network, for example, using balloon-to-balloon transmissions (e.g., using terminals, as described herein); providing high level earth observations (e.g., taking remote sensing measurements of the earth (e.g., using cameras, laser ranging, or other sensors), collecting and transmitting data about and for a system of Internet of things (IoT), and meteorological observations); performing other observational services (e.g., surveillance, gathering wind information, gathering other weather information); following a mapped trajectory (e.g., performing a flight that loops back to the target service region periodically) to provide services while in a target service region; other collaborative tasks to enable more efficient and precise operation by the fleet. Example objectives also may include, without limitation, test objectives, such as test objectives associated with a service region (e.g., obtaining environmental data in a service region, learning the winds in a certain region or location, or otherwise taking sensor readings in and around a service region, or other test objectives relating to observing the environment), test objectives associated with vehicle components (e.g., testing limitations of vehicle components), test objectives associated with software (e.g., testing new releases of navigation software, controllers, flight policies), and termination or landing objectives (e.g., position a vehicle to within range of a landing zone, navigate a vehicle to a landing zone by the time it reaches a predetermined minimum estimated lifetime). For example, a test objective may be to determine whether a new hardware or other components (e.g., a balloon envelope, a gimbal, a down connect, etc.) are airworthy, to collect data about said new hardware or other components, testing a new steering algorithm to understand performance and limitations, to collect data about a vehicle's and/or steering algorithm's performance to refine a simulation model, to understand the variance between vehicles of a same class (e.g. how much balloon to balloon variance is there on power draw, solar collection, ascent/descent rates, battery charge/discharge, film solar and IR absorptivity, etc), to accumulate flight-hours to unlock service flights (e.g. where an amount of flight-hours with a feature (e.g., lateral propulsion) is required over an unpopulated area (e.g., large body of water, other uninhabitable areas) to allow flight over land), to make more accurate end-of-life and reliability thresholds (e.g., to determine when different parts are going to fail).

Example objectives also may include, without limitation, other objectives layered onto any of the above objectives, such as conserving energy or minimizing energy consumption during a time period of flight or in achieving any of the aforementioned objectives; and achieving any of the aforementioned objectives in coordination with other aerial vehicles (i.e., in the context of a fleet of aerial vehicles).

Vehicle allocator 502 may be configured to allocate vehicles to recovery dispatcher 504, service dispatcher 506 and test dispatcher 508, using a set of rules, heuristics, agent-based models (e.g., bidding, auction), and machine learning models. For example, vehicle allocator 502 may entertain bids for vehicles from one or more of recovery dispatcher 504, service dispatcher 506 and test dispatcher 508, for one or more vehicles from fleet 512. For example, a dispatcher may be matched with, or assigned, a set of objectives, may determine the numbers and types of vehicles (e.g., vehicles with desired characteristics, currently located or ready to launch in a desired region) desired for optimal fulfillment of the set of objectives, and may select vehicles from fleet 512 based on these determinations to bid on. Upon receiving bids, vehicle allocator 502 may allocate one or more aerial vehicles to a dispatcher based on various factors (e.g., number of vehicles available, number of vehicles requested or bid on, priority of a region or objective). In some examples, a bid from a dispatcher may comprise a probability of successful completion of an objective with a selected aerial vehicle or set of selected aerial vehicles, which may take into account factors such as vehicle availability, priority (e.g., of region, of contract, of objective or objective type), and other factors. In other examples, a bid from a dispatcher may comprise a value indicating a likelihood of successful completion of an objective with a selected aerial vehicle or set of selected aerial vehicles. In still other examples, other allocation algorithms may be implemented (e.g. integer programming, auctions (i.e., a version of bidding that allows for re-bids or bid changes), neural network, or other logic).

There may be multiple recovery dispatchers 504, multiple service dispatchers 506, and multiple test dispatchers 508, each configured to dispatch to different geographical locations or regions, such as countries, states, municipalities, continents, island chains, bodies of water, and parts or regions thereof (e.g., Peru, State of Nevada, State of Oregon, the southwestern United States, Kenya, Northern Europe, Indonesia, French Polynesia, Queensland, Arabian Peninsula, South China Sea, Gulf of Mexico, etc.). In some examples, one or more of recovery dispatcher 504, service dispatcher 506 and test dispatcher 508 may bid on one or more objectives by determining whether the geographical region and/or purpose indicated by the objective matches with the dispatcher's domain (e.g., each of service dispatcher 506 may bid on service objectives for its respective geographical domain, each of recovery dispatcher 504 may bid on recovery objectives for its respective geographical domain or purpose, each of test dispatcher 508 may bid on test objectives for its respective geographical domain or purpose).

Each dispatcher may determine an “intent” for the aerial vehicle based on an assigned objective, the intent including at least a type of flight controller (e.g., for navigation to a destination, for station keeping around a destination, for performing system tests in a test zone, for landing in a recovery zone, etc.) and a destination (e.g., a goal or target location or region) for the aerial vehicle. The intent may additionally, or alternatively, include or represent a desired configuration (e.g., vehicle type (e.g., balloon, airship, fixed-wing, wind-driven, powered, a combination thereof or unspecified), vehicle size, communication capabilities (e.g., hardware and/or software configured for communication via a specified standard or protocol), hardware or software version or some combination thereof, for example, to support types of operational modes, flight modes, safety modes, power modes, fallback modes, communications modes, or other system or component modes).

Ephemeral logic 510 may be configured to perform real-time assurance checks based on state data that meets an overriding consideration, such as being on a heading towards and/or within a proximity of a no-fly zone or dangerous weather, or approaching zero-pressure or bursting pressure conditions. Where ephemeral logic 510 determines that an aerial vehicle's present state (e.g., location, altitude, pressure, heading) meets a condition or threshold of an overriding consideration, ephemeral logic 510 is configured to override the intent generated by a dispatcher and assign an appropriate real-time assurance controller (e.g., configured to navigate around a no-fly zone or dangerous weather, to navigate to a safe altitude, to determine an appropriate level of air intake or release or ballast drop, apply an appropriate level of propulsion for an appropriate amount of time) for the duration that the condition or threshold of the overriding condition is applicable. Once the overriding consideration is no longer applicable (e.g., aerial vehicle is past the no-fly zone or dangerous weather, has avoided dangerous pressure conditions, etc.), the aerial vehicle may continue to operate according to the intent provided by its dispatcher.

In some examples, vehicle allocator 502, any dispatcher described herein, and ephemeral logic 510, also may receive one or any combination of other inputs, including lifetime estimation for each vehicle, manual override instructions, equipment (e.g., mechanical components, hardware, software, vehicle types, etc.) requirements or preferences for each type of dispatcher (e.g., each service region, each type of objective), the demand or vehicle needs for each type of dispatcher, simulations of flights, alarms that may be alerting various conditions, and outputs of various other data streams produced to allow high level decision making for a fleet of aerial vehicles.

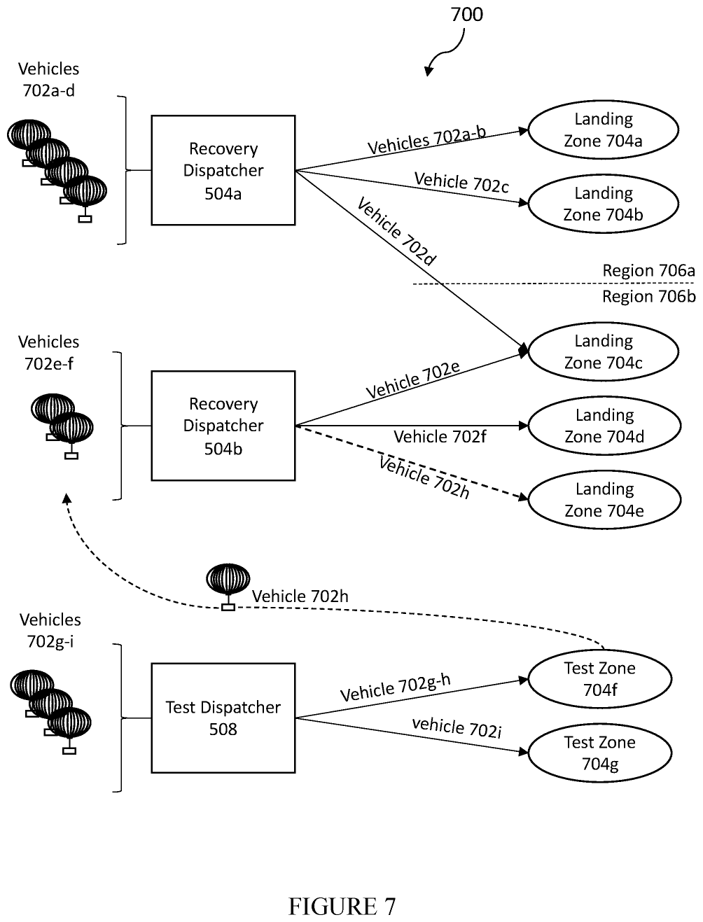

FIG. 6 is a simplified block diagram of exemplary dispatchers dispatching vehicles, in accordance with one or more embodiments. In diagram 600, vehicles 602a-d are being allocated to service dispatcher 506a, which has been configured to dispatch vehicles to target service locations within region 606a, which as described above, may include a country, body of water, state, municipality, regions within, or other parts or types of geographical locations. Within region 606a, there are exemplary target service locations 604a-b, and in an example, service dispatcher 506a may dispatch vehicles 602a-b to target service location 604a based on service objectives providing for connectivity services to target service location 604a and vehicles 602c-d to target service location 604b based on service objectives providing for connectivity services to target service location 604b. Vehicles 602e-i are being allocated to service dispatcher 506b, which has been configured to dispatch vehicles to target service locations within region 606b. Within region 606b, there are exemplary target service locations 604c-d, and in an example, service dispatcher 506b may dispatch vehicles 602e-g to target service location 604c based on service objectives providing for connectivity services to target service location 604c and vehicles 602h-i to target service location 604d based on service objectives providing for connectivity services to target service location 604d. As described herein, such service objectives may specify a service region, minimum bandwidth availability at all times, target bandwidth availability at peak times and non-peak times (e.g., mornings, afternoons, evenings, overnight, daytime, nighttime, specified hours, etc.), minimum or specified communications capabilities (e.g., 3G or 4G and up, transmit and receive certain ranges on a radio wave spectrum, etc.), minimum or required hardware and software versions, maximum age of vehicle, minimum remaining lifetime, and other aspects, as described herein.

In some examples, after performing a service objective until it is complete (i.e., fulfilled) or until the vehicle no longer meets one or more criteria for that service objective, a vehicle may be re-allocated (e.g., by vehicle allocator 502) to a different dispatcher. If the service objective for target service location 604c changes (e.g., requiring fewer vehicles going forward) or is complete, one or more of vehicles 602e-i may be re-allocated to different dispatchers. For example, if target service location 604c no longer requires as many vehicles to perform its service objective, vehicle 602f may be re-allocated (i.e., allocated for a next time period) to service dispatcher 506a to be dispatched to a service target service location within region 606a (e.g., location 604a, location 604b, or other location in region 606a). Vehicle allocator 502 may allocate vehicle 602f based on state data indicating vehicle 602f meets the criteria or conditions for service objectives associated with one or more target service locations in region 606a. For example, a current location of vehicle 602f and wind pattern information may indicate that vehicle 602f is able to navigate to a target service location for which service dispatcher 506a is responsible in time to perform a service objective in region 606a. Other state data, such as vehicle configuration, type and versioning, may indicate that vehicle 602f has the necessary capabilities to perform a service objective in region 606a. In another example, others of vehicles 602e-i may be dispatched to other target service locations within region 606b.

If one or more of vehicles 602e-i no longer meets one or more criteria for that service objective, such vehicle(s) may be re-allocated to a recovery dispatcher. For example, vehicle 602h may no longer be able to service target service location 604d after performing a service objective for target service location 604d for a while, whether or not said service objective has been fulfilled or completed. Once vehicle allocator 502 determines vehicle 602h no longer meets the criteria for target service location 604d, vehicle allocator 502 may reallocate vehicle 602h to recovery dispatcher 504, which may be configured to dispatch vehicles to decommissioned vehicle zones within region 606b such as location 604e. In an example, location 604e may comprise a landing zone selected by recovery dispatcher 508, in which vehicle 602h may be directed to land. In another example, not shown, vehicle 602h may be re-allocated to test dispatcher 508, and location 604e may comprise a test zone in which test objectives matching the state and capabilities of vehicle 602h may be performed. In another example, location 604e may overlap with a target service location for which test objectives are desired. Location 604e may be selected by test dispatcher 508 or recovery dispatcher 504 for performing tests or for landing vehicle 602h, respectively, using methods described herein.

In some examples, a dispatcher's region may encompass more than one country, state, or area (e.g., a country and adjacent body of water, a group of islands belonging to more than one country along with the surrounding or adjacent bodies of water, all the countries in a region of a continent). For example, location 604a may comprise country A and location 604b may comprise country B. Service dispatcher 506a may dispatch one or both of vehicles 602a-bto country A (location 604a) for a certain time period, then with the expectation that one or both of vehicles 602a-b may drift or otherwise navigate towards country B (location 604b) in completing part or all of a service objective for location 604a, service dispatcher 506a may dispatch one or both of vehicles 602a-b to perform part or all of a service objective for country B (location 604b).

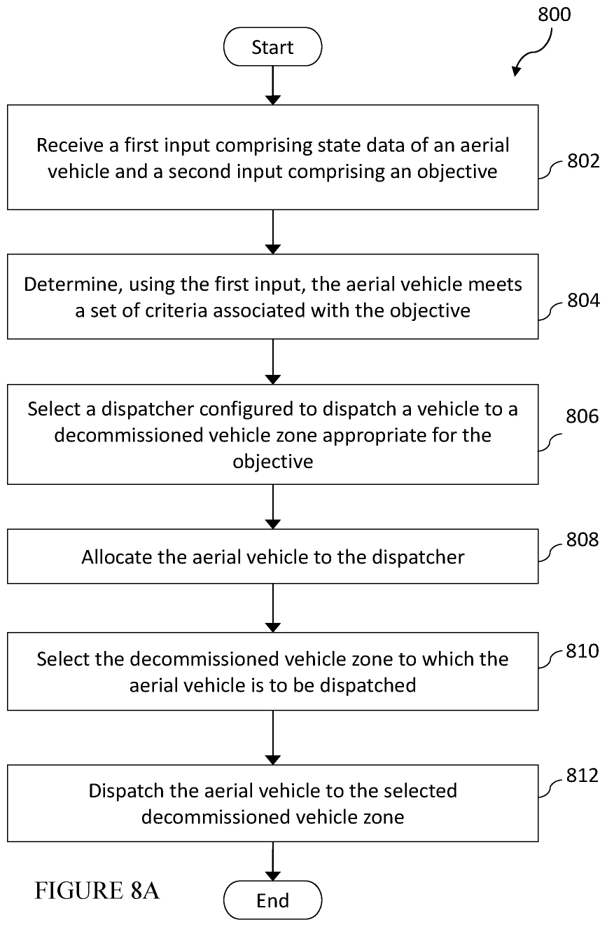

FIG. 7 is another simplified block diagram of exemplary dispatchers dispatching vehicles, in accordance with one or more embodiments. In diagram 700, vehicles 702a-d are being allocated to recovery dispatcher 504a, which has been configured to dispatch vehicles to landing zones within region 706a, vehicles 702e-f are being allocated to recovery dispatcher 504b, which has been configured to dispatch vehicles to landing zones within region 706b, and vehicles 702g-i are being allocated to test dispatcher 508, which has been configured to dispatch vehicles to test zones within region 706b. Within region 706a, there are exemplary landing zones 704a-b, and in an example, recovery dispatcher 504a may dispatch vehicles 702a-b and 702c to landing zones 704a and 704b , respectively, to perform landing objective(s) related to those locations. Within region 706b, there are exemplary landing zones 704c-e, and in an example, recovery dispatcher 504b may dispatch vehicles 702e and 702f to landing zones 704c-d, respectively, to perform landing objective(s) related to those locations. Also within region 706b, there are exemplary test zones 704f-g, and in an example, test dispatcher 508 may dispatch vehicles 702g-h and 702i to test zones 704f-g, respectively, to perform test objective(s) related to those locations. In an example, if vehicle 702h completes one or more test objectives related to test zone 704f, and it is determined that vehicle 702h meets a criterion for landing (e.g., within a threshold minimum lifetime estimate, simulations indicative of being within a lifetime estimation range required for navigating to a landing zone, unforecasted failure, manual designation for landing) , for example, in nearby landing zone 704e or other landing zone. In other examples, vehicle 702h may be reallocated to another test dispatcher to perform other tests wherein vehicle 702h has not met a criterion for landing and is capable of performing further tests.

### Example Methods

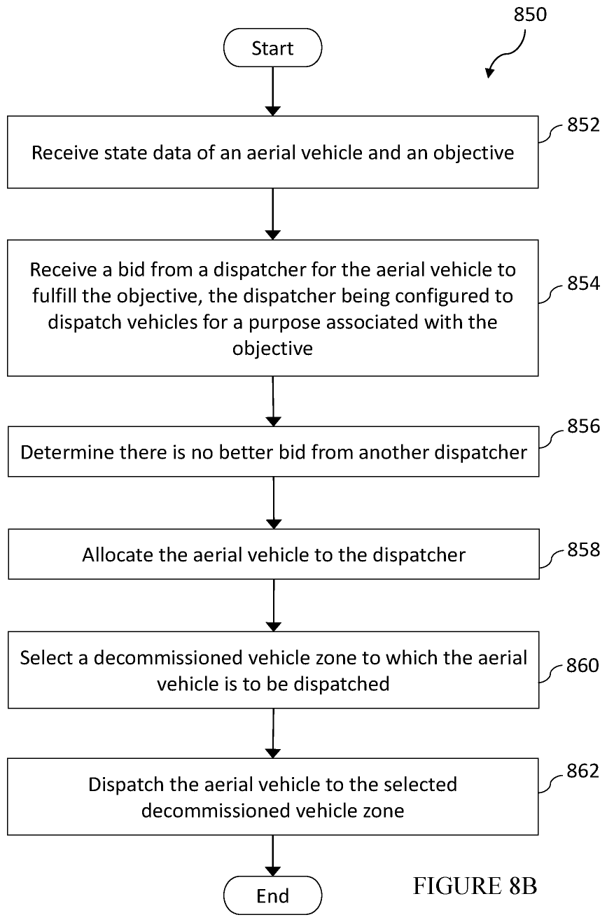

FIGS. 8A-B are flow diagrams illustrating methods for allocating an aerial vehicle to a test or recovery dispatcher to fulfill an objective, in accordance with one or more embodiments. Method 800 begins with receiving a first input comprising state data of an aerial vehicle and a second input comprising an objective at step 802. The objective may be a test objective or a landing objective. A determination may be made using the first input that the aerial vehicle meets a set of criteria associated with the objective at step 804, for example, by a vehicle allocator or dispatcher, as described herein. A dispatcher may be selected by a vehicle allocator at step 806, the dispatcher configured to dispatch a vehicle to a decommissioned vehicle zone appropriate for the objective. For example, a test dispatcher configured to dispatch a vehicle to a decommissioned vehicle zone comprising a test zone may be selected for a test objective, and a recovery dispatcher configured to dispatch a vehicle to a decommissioned vehicle zone comprising a landing zone may be selected for a recovery objective. In another example, there may be decommissioned vehicle zones in various unpopulated areas (e.g., rural land, unfrequented areas of large bodies of water, relatively unpopulated islands) that are available and optimal for performing certain types of test objectives (e.g., testing (i.e., gathering data on) outside bounds of ACS usage with frequent altitude changes, testing outside bounds of power consumption in certain conditions (e.g., at night, for back-up systems, in certain modes), testing flights at the outside bounds of an aerial vehicle's altitude range, testing fleet coordination with multiple aerial vehicles flying in close proximity, testing effectiveness and robustness of new software, testing actual lifetimes of vehicle components, and more). In some examples, such decommissioned vehicle zones also may be in geographical areas with more extreme weather conditions (e.g., temperatures, pressures, daylight or lack thereof, wind forces and debris). In another example, there may be decommissioned vehicle zones overlapping with service zones, wherein actual or real-time environmental data is desired. In yet another example, there may be decommissioned vehicle zones designated for termination or landing objectives, wherein landing rights have been reserved. In some examples, the landing rights may be on land or an offshore platform that is commonly owned with the vehicle, such that the vehicle can land at any time that is convenient to the vehicle. In other examples, landing rights may be on shared or rented land or offshore platform, such that the vehicle can land only at certain designated or predetermined times (e.g., time range for one or more given days of the week, sunrise to sunset on specified days or dates, varying time windows for different days of the week, anytime on a specified date or series of dates, or other designated times).

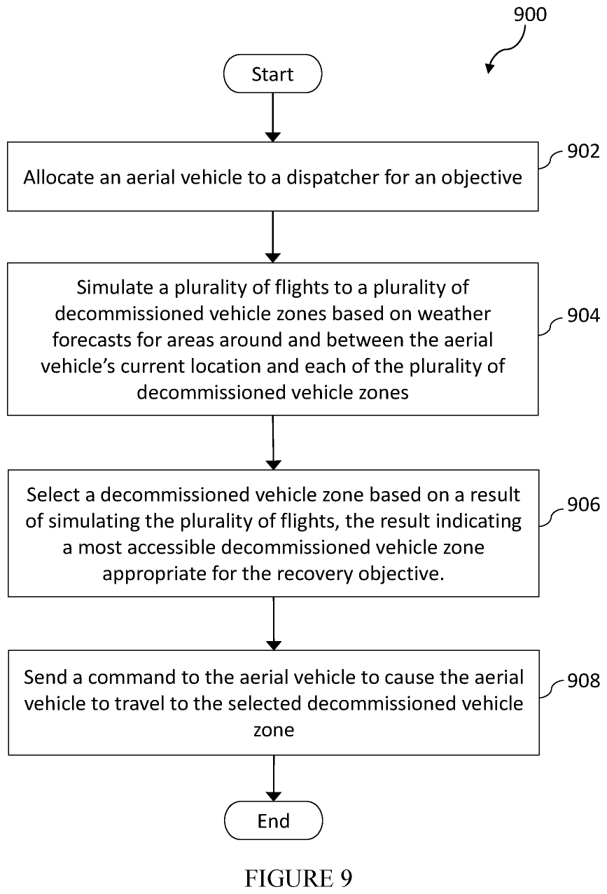

At step 808, the aerial vehicle may be allocated to the selected dispatcher. As the selected dispatcher may be configured to dispatch to multiple decommissioned vehicle zones that are within the dispatcher's domain (e.g., within a region serviced by the selected dispatcher, or purposed appropriately for testing and/or termination), the dispatcher may need to select the decommissioned vehicle zone to which the aerial vehicle is to be dispatched from two or more options at step 810. An example method for selecting a decommissioned vehicle zone is described below, as shown in FIG. 9. Once a decommissioned vehicle zone is selected, the aerial vehicle may be dispatched to the selected decommissioned vehicle zone at step 812.

Alternatively, method 850 may begin with receiving, by a test or recovery dispatcher, state data of an aerial vehicle and an objective at step 852. In an example, a vehicle allocator may provide a list of available vehicles in the fleet to the test or recovery dispatcher, along with state data or characteristics derived from the state data for the available vehicles. The dispatcher may also receive an objective as input from the vehicle allocator or other module that is appropriate for the dispatcher's domain (e.g., by geography and/or by purpose). Based on these inputs (i.e., list of available vehicles, state data and/or characteristics of the available vehicles, and objective), as well as other inputs (e.g., weather maps and forecasts, other types of maps, types of controllers, other system information), the dispatcher may determine a number of vehicles it needs to perform the objective (e.g., if a test objective indicates a request for a certain large amount of data that is desired within a given time frame, then it may take a certain number of vehicles to complete the test objective; if a test objective relates to testing software for coordinating multiple vehicles, then it may take two or more vehicles to complete the test objective; if a test objective is to gather one or more types of sensor data (e.g., images, wind patterns) in an area with minimal resource spend, then it may take one vehicle to complete the test objective; if a recovery objective is targeted to landing a single vehicle, rather than a group of vehicles, then there may be only one vehicle for a recovery dispatcher to bid on). In some examples, the recovery objective will specify or suggest an exact, minimum, or maximum number of vehicles to be used, and the dispatcher may select a vehicle based on said specified or suggested value and the characteristics of the available vehicles.

The vehicle allocator may receive a bid from the dispatcher for the aerial vehicle to fulfill the objective at step 854, the dispatcher being configured to dispatch vehicles for a purpose associated with the objective. For example, the objective may be associated with a geographical region and the dispatcher may be purposed with dispatching to the geographical region. In another example, the objective may comprise a recovery objective, and thus may be matched or assigned to a recovery dispatcher purposed for dispatching to decommissioned vehicle zones comprising landing areas. In yet another example, the objective may comprise a test objective, and thus may be matched or assigned to a test dispatcher purposed for dispatching to decommissioned vehicle zones comprising test areas. In these examples, dispatching may include selecting an appropriate or optimal decommissioned vehicle zone (i.e., running simulations or obtaining output from simulators to determine an optimal decommissioned vehicle zone), selecting an appropriate controller, and flying the aerial vehicle to the selected decommissioned vehicle zone. In some examples, the bid may comprise a value or score indicating how well the aerial vehicle matches the objective.

The vehicle allocator may then determine that there is no better bid from another dispatcher at step 856. In an example, the vehicle allocator may receive no other bids for the aerial vehicle. In another example, the vehicle allocator may receive competing bids for the aerial vehicle that are not better (e.g., do not have a higher value or score, are not better matched for the other objectives), the competing bids being from either other recovery or test dispatchers, service dispatchers, or still other dispatchers. Upon said determination, the vehicle allocator may allocate the aerial vehicle to the dispatcher at step 858.

The dispatcher to which the aerial vehicle has been allocated may then select a decommissioned vehicle zone to which the aerial vehicle is to be dispatched at step 860. Such selection may be performed by the method described in FIG. 9, or by another process. Once a decommissioned vehicle zone is selected, the recovery dispatcher may dispatch the aerial vehicle to the selected decommissioned vehicle zone at step 862.

In some examples, said dispatching steps 812 and 862 may include the test or recovery dispatcher sending a message or command to the aerial vehicle indicating an intent (e.g., for the aerial vehicle to travel to the selected decommissioned vehicle zone or a location associated or within, for the aerial vehicle to perform certain tasks upon arrival at the selected decommissioned vehicle zone). In some examples, said dispatching step also may include the test or recovery dispatcher assigning a controller to the aerial vehicle. In other examples, the intent indicated by a test or recovery dispatcher may be overridden by overriding intents from a real-time assurance layer (e.g., ephemeral logic 510), which will temporarily assign a different controller for steering the aerial vehicle out of or around an area of overriding concern (e.g., a no-fly zone, dangerous weather conditions, other conditions specifically dangerous to the aerial vehicle itself).

FIG. 9 is a flow diagram illustrating a method for selecting a decommissioned vehicle zone, in accordance with one or more embodiments. Method 900 may begin with allocating an aerial vehicle to a dispatcher for an objective at step 902. The aerial vehicle may be allocated to a test dispatcher for a test objective, and a recovery dispatcher for a recovery objective. A plurality of flights to a plurality of decommissioned vehicle zones may be simulated based on weather forecasts for areas around and between the aerial vehicle's current location and each of the plurality of decommissioned vehicle zones at step 904. The decommissioned vehicle zones may be test zones if the objective comprises a test objective, and may be landing zones if the objective comprises a recovery objective. In some examples, these simulations may be performed by a simulation stack separate from the dispatcher, the simulation stack trained to evaluate possible flight paths to various decommissioned vehicle zones within the purview of the dispatcher, in view of the objective, and to provide a result in the form of a score, a probability distribution, or other output configured to indicate to the dispatcher, or from which the dispatcher is configured to determine, which of the decommissioned vehicle zones is optimal for the objective. Based on the result of simulating the plurality of flights, the dispatcher may select a decommissioned vehicle zone for the aerial vehicle to perform the objective at step 906. The result may indicate a most accessible decommissioned vehicle zone appropriate for the objective, which may be based on a distance to the decommissioned vehicle zone, an estimated time of arrival at the decommissioned vehicle zone, how well the decommissioned vehicle zone meets the requirements or desires of the objective, and other factors, which may be considered individually and summed, weighted, averaged, or evaluated by another function. Once a decommissioned vehicle zone is selected, a command may be sent to the aerial vehicle to cause the aerial vehicle to travel to the selected decommissioned vehicle zone at step 908. In some examples, the test or recovery dispatcher may assign to the aerial vehicle a controller configured to send control signals to the aerial vehicle to fly it to the selected decommissioned vehicle zone. In other examples, the test or recovery dispatcher may send one or more direct commands or messages to the aerial vehicle.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A computer-implemented method comprising:
receiving a first input comprising state data of an aerial vehicle and a second input comprising an objective;
determining, using the first input, the aerial vehicle meets a set of criteria associated with the objective;
selecting a dispatcher configured to dispatch a vehicle to a decommissioned vehicle zone;
allocating the aerial vehicle to the dispatcher; and
selecting, by the dispatcher, the decommissioned vehicle zone to which the aerial vehicle is to be dispatched,
wherein the objective comprises a test objective or recovery objective, and
wherein the dispatcher comprises a test dispatcher or recovery dispatcher.

2. The method of claim 1, wherein the decommissioned vehicle zone comprises a geographical area for which there are test or recovery objectives to perform.

3. The method of claim 1, wherein the decommissioned vehicle zone comprises a test area wherein aerial vehicles can perform test objectives.

4. The method of claim 1, wherein the decommissioned vehicle zone comprises a landing area wherein aerial vehicles can land.

5. The method of claim 1, further comprising
simulating, based on a third input comprising a weather forecast for areas around and between a current location of the aerial vehicle and the decommissioned vehicle zone, one or more flights that the aerial vehicle can perform to arrive at the decommissioned vehicle zone;
selecting, by the dispatcher, a flight based on a plurality of simulations; and
sending, by the dispatcher, a first command to the aerial vehicle, the first command configured to cause the aerial vehicle to navigate to the decommissioned vehicle zone based on the selected flight.

6. The method of claim 5, wherein the aerial vehicle is a wind-driven vehicle and the first command comprises an instruction for the aerial vehicle to ascend or descend to an altitude configured to cause the aerial vehicle to be driven by wind in a desired heading.

7. The method of claim 5, further comprising:
determining a distance range from the decommissioned vehicle zone wherein the aerial vehicle should begin a descent to land in the decommissioned vehicle zone, wherein the decommissioned vehicle zone comprises a landing area; and
sending a second command to the aerial vehicle when the aerial vehicle is within the distance range.

8. The method of claim 7, wherein the aerial vehicle comprises a wind-driven vehicle and the second command comprises a termination command to cause the wind-driven vehicle to begin the descent while continuing to be carried to the landing zone by wind.

9. The method of claim 5, further comprising sending a second command to the aerial vehicle to perform a test objective, wherein the objective comprises the test objective.

10. The method of claim 5, wherein the flight is selected based on a shortest distance to the decommissioned vehicle zone.

11. The method of claim 5, wherein the flight is selected based on a shortest time of flight to the decommissioned vehicle zone.

12. The method of claim 5, wherein the flight is selected based on a time frame when the decommissioned vehicle zone is available for landings.

13. The method of claim 1, wherein the state data includes an estimate of remaining lifespan for the aerial vehicle, said remaining lifespan comprising one criterion in the set of criteria for the objective.

14. The method of claim 1, wherein the decommissioned vehicle zone overlaps with a service area for which there is a test objective and a service objective.

15. The method of claim 14, wherein the objective comprises a test objective associated with gathering environmental data for the service area.

16. The method of claim 1, wherein selecting the dispatcher is based on a geographical region associated with the objective.

17. A distributed computing system for fleet management and flight planning, the system comprising:
one or more computers and one or more storage devices, the one or more storage devices storing instructions that when executed cause the one or more computers to implement;
a vehicle allocator configured to:
receive a first input comprising state data of an aerial vehicle and a second input comprising an objective,
determine, using the first input, the aerial vehicle meets a set of criteria associated with the objective,
select a dispatcher configured to dispatch a vehicle to a decommissioned vehicle zone, and
allocate the aerial vehicle to the dispatcher; and
a dispatcher configured to select the decommissioned vehicle zone to which the aerial vehicle is dispatched, the dispatcher comprising a test dispatcher or recovery dispatcher.

18. The distributed computing system of claim 17, wherein the dispatcher further is configured to:
select a flight based on a plurality of simulations; and
send a first command to the aerial vehicle, the first command configured to cause the aerial vehicle to navigate to the decommissioned vehicle zone based on the selected flight.

19. The distributed computing system of claim 17, wherein the one or more computers reside in a ground station comprising a plurality of server computing devices.

20. The distributed computing system of claim 17, wherein the dispatcher comprises a plurality of dispatchers, each of the plurality of dispatchers being configured to dispatch vehicles to a different geographical region.
